(19) United States
(12) Patent Application Publication
(10) Pub. No.: US 2008/0131849 A1
(43) Pub. Date: Jun. 5, 2008

(54) APPARATUS AND METHOD FOR GENERATING TACTILE SENSATION BY USING CONSTELLATION METAPHOR

(76) Inventors: Ki Uk KYUNG, Daejeon (KR); Ji Eun Park, Seoul (KR); Jun Seok Park, Daejeon (KR); Dong Won Han, Daejeon (KR)

Correspondence Address: RABIN & Berdo, PC, 1101 14TH STREET, NW, SUITE 500, WASHINGTON, DC, 20005, US

(21) Appl. No.: 11/948,913

(22) Filed: Nov. 30, 2007

(30) Foreign Application Priority Data
Dec. 1, 2006 (KR) 10-2006-0121059
Aug. 3, 2007 (KR) 10-2007-0078190

(51) Int. Cl. G09B 21/00

(52) U.S. Cl. 434/114

(57) ABSTRACT

An apparatus and method for generating tactile sensation by using constellation metaphor are provided. The apparatus includes: a tactile generator generating a tactile pattern by using a shape of image inputted from a user and generating a tactile icon having a shape of dots and lines by using the constellation metaphor according to the tactile pattern; a tactile indicator indicating a tactile sensation by using the generated tactile pattern; and a display unit displaying the generated tactile icon. Accordingly, there is an advantage in that the tactile pattern is easily generated, and a user can easily recognize the generated tactile pattern.

### CROSS-REFERENCE TO RELATED APPLICATIONS

This application claims the priorities of Korean Patent Application No. 10-2006-121059 filed on Dec. 1, 2006, and No. 10-2007-78190 filed on Aug. 3, 2007, in the Korean Intellectual Property Office, the disclosure of which is incorporated herein by reference.

### BACKGROUND OF THE INVENTION

1. Field of the Invention

The present invention relates to an apparatus and method for generating tactile sensation by using constellation metaphor, and more particularly, to an apparatus and method for generating tactile sensation by using constellation metaphor which facilitates user recognition on a tactile pattern by allowing the tactile pattern to be easily implemented along with the provision of a tactile icon.

This work was supported by the IT R&D program of MIC/IITA [Project No. 2006-S-031-01, Five Sences Information Processing Technology Development for Network Based Reality Service].

2. Description of the Related Art

Recently, there are growing attempts to combine sensations other than audiovisual sensations with small-sized information devices.

In particular, tactile technologies are used in which a picture drawn by visually challenged people or a picture having a meaning defined by a user is converted into tactile sense by using actuators, that is, vibrations for delivering the tactile sense.

According to the currently available tactile technologies, a general picture is represented by a tactile actuator by simply reducing a resolution of the picture. Thus, there is a limit in conveying a specific meaning of the picture.

In addition, in the current tactile technologies, a vibration signal is not much related to a meaning of picture, and thus the meaning can be recognized by only a person who defines it. As a result, it is difficult to share the meaning with other people.

Therefore, a technique is required in which a tactile pattern that can be utilized in a message format used in a communication device and in which not only audiovisual sensations but also tactile sense can be delivered.

Accordingly, there is a need for a tactile pattern having a shape that can be further simplified and easily perceived by ordinary users.

### SUMMARY OF THE INVENTION

An aspect of the present invention provides an apparatus and method for generating tactile sensation by using constellation metaphor which facilitates user recognition on a tactile pattern by allowing the tactile pattern to be easily implemented along with the provision of a tactile icon.

According to an aspect of the present invention, there is provided an apparatus for generating tactile sensation by using constellation metaphor, the apparatus comprising: a tactile generator generating a tactile pattern by using a shape of image inputted from a user and generating a tactile icon having a shape of dots and lines by using the constellation metaphor according to the tactile pattern; a tactile indicator indicating a tactile sensation by using the generated tactile pattern; and a display unit displaying the generated tactile icon.

In the aforementioned aspect of the present invention, the tactile generator may divide the input image into a picture area and a background area, and generate the tactile pattern by simplifying an image for the picture area.

In addition, the tactile generator may regulate a ratio and size of the input image so that the input image is optimized for the tactile indicator, allow the picture and background areas divided from the image to correspond to actuators constituting the tactile indicator, and generate the tactile pattern by activating only an actuator corresponding to the picture area.

In addition, if it is determined that there is a existing tactile pattern having the same pattern as the activated actuator, the tactile generator may add dots or lines so as to distinguish the pattern of the activated actuator from the existing tactile pattern having the same pattern as the activated actuator or may provide a users editing process.

In addition, the tactile generator may allow locations of the activated actuators to be indicated by dots by using the constellation metaphor, and generate a tactile icon by connecting the indicated dots by lines.

In addition, if it is determined that there is a existing tactile icon having the same shape as a figure formed by connecting the dots by lines, the tactile generator may add dots or lines so as to distinguish the figure from the existing tactile icon having the same shape as the figure or may provide a user's editing process.

In addition, the tactile indicator may be a physical stimulator including an actuator by which a plurality of pins vertically moves or vibrates.

In addition, the display unit may further output a character format of an image name corresponding to the indicated tactile pattern.

In addition, the tactile generator may comprise: an image input unit receiving an image from the user and storing the image; a tactile pattern generator generating a tactile pattern corresponding to the image; and a tactile icon generator generating a tactile icon having a shape of dots and lines by using the constellation metaphor corresponding to the tactile pattern.

In addition, the tactile generation apparatus may further comprise an audio output unit outputting an audio format of an image name corresponding to the indicated tactile pattern.

According to another aspect of the present invention, there is provided a method of generating tactile sensation by using constellation metaphor, the method comprising: generating a tactile pattern by using a shape of image inputted from a user; generating a tactile icon having a shape of dots and lines by using the constellation metaphor corresponding to the tactile pattern; indicating the generated tactile pattern as a tactile sensation; and displaying the tactile icon corresponding to the tactile pattern indicated as the tactile sensation.

In the aforementioned aspect of the present invention, the generating of a tactile pattern may comprise: regulating a ratio and size of the image inputted from the user so that the image is optimized for an area that indicates the tactile sensation; dividing the optimized image into a picture area and a background area; allowing the divided picture and background areas to correspond to actuators constituted to provide the tactile sensation; and generating the tactile pattern in which only an actuator corresponding to the picture area is activated.

In addition, the method may further comprises, if it is determined that there is a existing tactile pattern having the same pattern as the activated actuator, adding dots or lines so as to distinguish the pattern of the activated actuator from the existing tactile pattern having the same pattern as the activated actuator, or providing a user's editing process.

In addition, the generating of a tactile icon corresponding to the tactile pattern may comprise: indicating locations of the activated actuators by dots by using the constellation metaphor; connecting the indicated dots by lines; and generating a figure formed by connecting the dots by lines as the tactile icon.

In addition, the method may further comprise, if it is determined that there is a existing tactile icon having the same shape as a figure formed by connecting the dots by lines, adding dots or lines so as to distinguish the figure from the existing tactile icon having the same shape as the figure, or providing a user's editing process.

In addition, in the providing of the generated tactile pattern as a tactile sensation, the tactile sensation may be indicated by using a physical stimulator including a plurality of pins of an actuator that vertically moves or vibrates.

In addition, the method may further comprise outputting an audio format of an image name corresponding to the indicated tactile pattern.

In addition, the method may further comprise displaying a character format of an image name corresponding to the indicated tactile pattern.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a tactile generation apparatus according to an embodiment of the present invention;

FIG. 2 is a block diagram illustrating a tactile generation system according to an embodiment of the present invention;

FIG. 3 is a flowchart illustrating a tactile generating method according to an embodiment of the present invention;

FIG. 4 illustrates an example of implementing a tactile generating system according to an embodiment of the present invention; and

FIG. 5 illustrates an example of a tactile pattern and a tactile icon according to an embodiment of the present invention.

### DETAILED DESCRIPTION OF THE PREFERRED EMBODIMENT

Preferred embodiments of the present invention will be described below with reference to the accompanying drawings so that those of ordinary skill in the art can readily implement the invention. In the following description, well-known functions or constructions are not described in detail since they would obscure the invention in unnecessary detail.

Throughout the drawings, like reference numerals denote like elements.

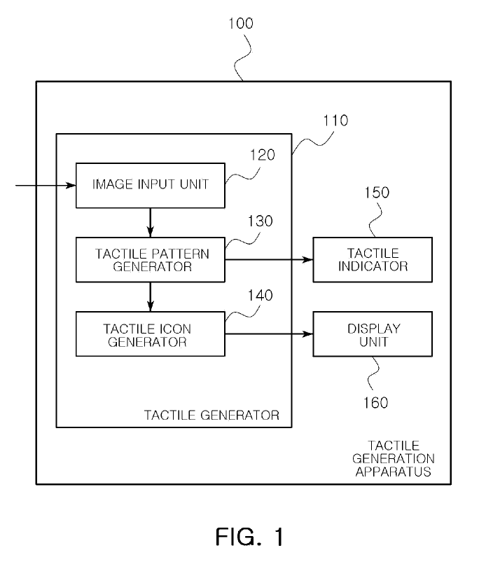

FIG. 1 is a block diagram illustrating a tactile generation apparatus 100 according to an embodiment of the present invention.

Referring to FIG. 1, the tactile generation apparatus 100 includes a tactile generator 110, a tactile indicator 150, and a display unit 160.

In the tactile generation apparatus 100, the tactile generator 110 includes an image input unit 120, a tactile pattern generator 130, and a tactile icon generator 140. The image input unit 120 receives an input image, which is simplified and symbolized, from a user and stores the input image. Examples of the input image may include a symbol image designed to be used for scheduling, an image modified from an MS-Windows icon, and so on. The tactile pattern generator 130 generates a tactile pattern corresponding to the input image. The tactile icon generator 140 generates an icon corresponding to the tactile pattern so that the user can visually check the generated tactile pattern.

The tactile pattern generator 130 divides the input image into a picture area and a background area, and then generates a tactile pattern by simplifying an image for the picture area. The tactile icon generator 140 generates a tactile icon composed of dots and lines by using constellation metaphor.

The tactile indicator 150 is a physical stimulator having a plurality of pins which vertically move or vibrate by an aid of an actuator. The tactile indicator 150 indicates the tactile pattern generated by the tactile generator 110 by using the plurality of pins. The display unit 160 displays the tactile icon generated by the tactile generator 110.

In the tactile generation apparatus 100 of the present invention, an image name corresponding to the tactile pattern indicated by the tactile indicator 150 can be displayed in a character format on the display unit 160. Furthermore, an audio output unit (not shown) may be provided to output the image name in an audio format.

Thus, the tactile generation apparatus 100 generates a tactile pattern and icon corresponding to an image inputted from the user by the use of the tactile generator 110, and thereafter indicates the generated tactile pattern and icon by using the tactile indicator 150 and the display unit 160 at the request of the user. Therefore, the user can check an image pattern by using tactile sense and check a tactile icon corresponding to the tactile pattern by using visual sensations.

In addition, by outputting the image name corresponding to the indicated tactile pattern in a charter or audio format, the user can easily recognize the tactile pattern.

Accordingly, the present invention may be applied to a web program or an application program so that a visually challenged people can perceive the tactile pattern while checking a graphic user interface (GUI) element by using an audio signal.

Although it has been described that tactile sensation and images are implemented using one apparatus, the present invention is not limited thereto. Thus, a tactile pattern and a tactile icon may be generated and implemented using different apparatuses.

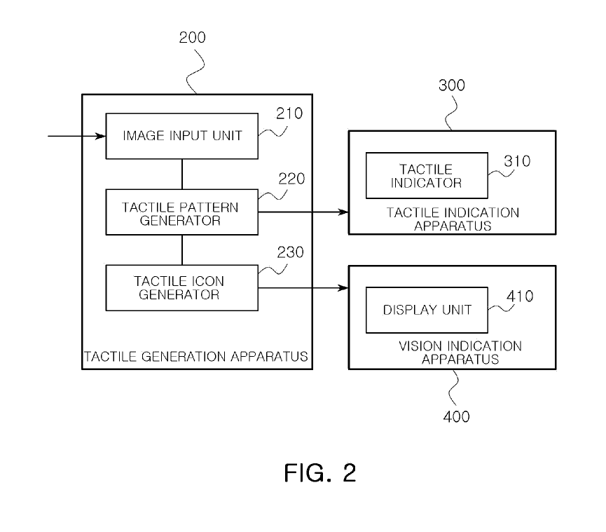

FIG. 2 is a block diagram illustrating a tactile generation system according to an embodiment of the present invention.

Referring to FIG. 2, the tactile generation system includes a tactile generation apparatus 200, a tactile indication apparatus 300, and a vision indication apparatus 400.

The tactile generation apparatus 200 includes an image input unit 210, a tactile pattern generator 220, and a tactile icon generator 230. The image input unit 210 receives an image inputted from a user. The tactile pattern generator 220 generates a tactile pattern corresponding to the input image. The tactile icon generator 230 generates an icon corresponding to the tactile pattern by using constellation metaphor so that the user can visually check the generated tactile pattern.

The tactile indication apparatus 300 includes a tactile indicator 310 having a plurality of pins which vertically move or vibrate by an aid of an actuator. Thus, the tactile pattern generated by the tactile generation apparatus 200 can be indicated by the tactile indicator 310. Further, the vision indication apparatus 400 includes a display unit 410 having a display screen so that a tactile icon generated by the tactile generation apparatus 200 can be displayed thereon.

In addition, in the tactile generating system of the present invention, an image name corresponding to the tactile pattern indicated by the tactile indication apparatus 300 can be displayed in a character format on the display unit 410 of the vision indication apparatus 400. Moreover, the image name can be output in an audio format by further providing an audio output unit (not shown).

Hereinafter, a tactile generation method will be described in detail which is performed by the tactile generation apparatus 100 and the tactile generating system, wherein the apparatus 100 and the system generate indicate a tactile pattern and icon corresponding to an image inputted from a user.

Now, the tactile generating method performed by the tactile generation apparatus 100 will be described for example.

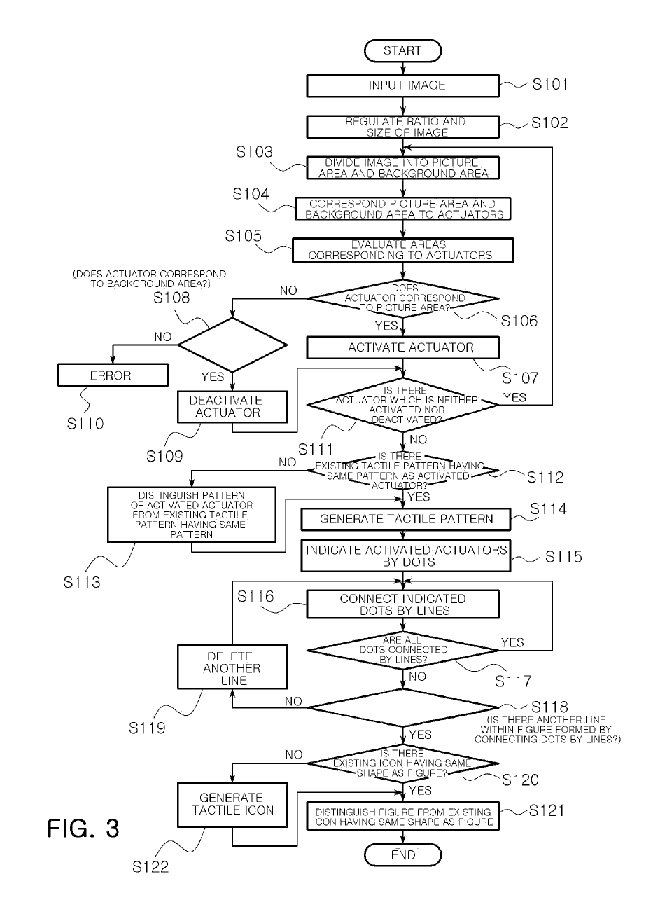

FIG. 3 is a flowchart illustrating the tactile generating method performed by the tactile generation apparatus 100 according to an embodiment of the present invention.

Referring to FIG. 3, the tactile generation apparatus 100 receives an image (e.g., icon, symbol, etc.) inputted from a user (step S101). The input image needs to be subject to tactile pattern generation. Then, a ratio and size of the image are regulated so that the input image is optimally indicated by the tactile indicator 150 (step S102).

The input image is divided into a picture area and a background area (step S103). The picture area and the background area are matched to corresponding actuators (step S104). Areas corresponding to the actuators are evaluated (step S105).

For each actuator, it is checked whether an actuator corresponds to the picture area (step S106). If the actuator corresponds to the picture area, the actuator is activated (step S107). Otherwise, it is checked whether the actuator corresponds to the background area (step S108). If the actuator corresponds to the background area, the actuator is deactivated (step S109). If the actuator corresponds to neither the picture area nor the background area, ‘ERROR’ handling is performed (step S110).

After all actuators are activated or deactivated according to whether each actuator corresponds to the picture area or the background area as described above, it is checked again whether there is an actuator which is neither activated nor deactivated (step S111). For the actuator which is neither activated nor deactivated, steps 104 to 107 are repeated so that the actuator is activated or deactivated according to whether the actuator corresponds to the picture area or the background area of the image.

When it is determined that all actuators are activated or deactivated according to whether each actuator corresponds to the picture area and the background area, it is checked whether there is a existing tactile pattern having the same pattern as the activated actuator (step S112).

According to whether the existing tactile pattern is present or not, dots or lines may be added so that the pattern of the activated actuator can be distinguished from the existing tactile pattern having the same pattern, or a user's editing process may be performed (step S113). Thereafter, a tactile pattern corresponding to the image inputted from the user is generated (step S114).

That is, in order to prevent the same tactile pattern from being generated by using different images, a currently activated actuator is modified according to a predetermined condition.

As a result, a tactile pattern generated at the request of the user can be implemented by using the tactile indicator 150.

Next, locations of the activated actuators are indicated by dots (step S115). The indicated dots are connected by lines (step S116).

That is, as if starts are connected by lines to form a constellation, adjacent dots are first connected, and farthest dots are last connected, thereby forming one figure by using the indicated dots.

It is checked whether all dots are connected in the aforementioned linearlization process (step S117). The linearlization process is repeatedly performed on unconnected dots (steps S116 and S117).

If it is determined that all dots are connected by the linearlization process, it is checked whether there is another line that is not included within the figure generated by the linearlization process (step S118).

If it is determined that another line exists, another line is deleted (step S119). Thereafter, a series of steps are repeated to connect unconnected dots by lines and to determine whether there is another line within the figure (steps S116 to S118).

If it is determined that another line does not exist within the figure generated in the linearlization process, according to whether an icon having the same shape as the generated figure is detected or not, dots or lines may be added so that the generated figure can be distinguished from the icon having the same shape as the figure, or a user's editing process may be performed (steps S120 and S121). Then, an icon corresponding to the generated tactile pattern is generated (step S122).

Thus, the icon of the tactile pattern generated at the request of the user is displayed on the display unit 160.

Meanwhile, according to another embodiment of the present invention, the tactile generating system may generate a tactile pattern and a tactile icon and indicate the generated tactile pattern and tactile icon in the same manner as described above in the tactile generating method of FIG. 3.

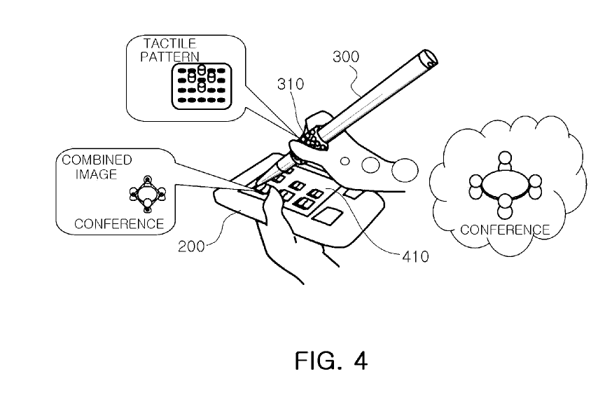

FIG. 4 illustrates an example of implementing a tactile generating system according to an embodiment of the present invention.

Referring to FIG. 4, the tactile generating system is implemented using a personal digital assistant (PDA) (i.e., the tactile generation apparatus 200) and the pen-type tactile indication apparatus 300. A tactile pattern and a tactile icon are generated by using the PDA. The generated tactile icon is displayed on the display unit 410. The generated tactile pattern is indicated by the pen-type tactile indicator 310 attached to the tactile indication apparatus 300.

In FIG. 4, a user clicks a GUI widget having a tactile icon through a GUI of the PDA display unit 410.

That is, when the user clicks an image combined with the tactile icon displayed on the PDA display unit 410, a tactile pattern is indicated by the tactile indicator 310 of the pen-type tactile indication apparatus 300.

Therefore, the user recognizes connectivity between the indicated tactile pattern and the image while using a PDA menu. The user can recognize which menu has been selected, without having to check the PDA display unit 410.

Thus, a function of the tactile generating system using the PDA may be effectively used when it is difficult for the user to check a screen in detail, for example, when the user records data in a PDA by using a pen-type element while watching and listening lectures or presentations.

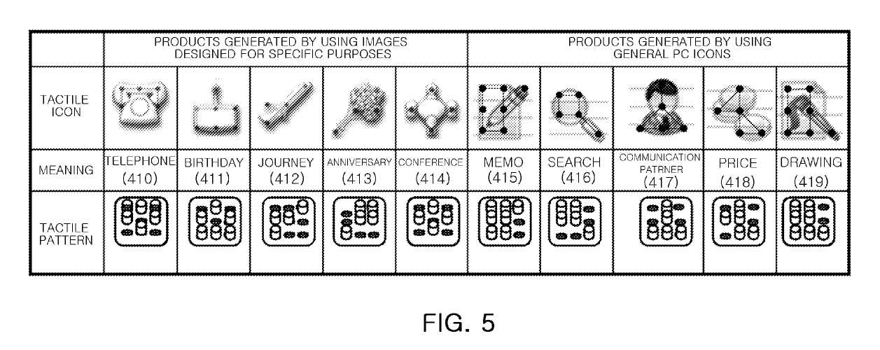

FIG. 5 illustrates an example of a tactile pattern and a tactile icon according to an embodiment of the present invention.

Referring to FIG. 5, the tactile icon and the tactile pattern which are generated by the tactile generation apparatus 100 or the tactile generating system may be either an icon generated by using an image designed for a specific purpose or an icon generated by using a general personal computer (PC) icon.

Examples of the image designed for a specific purpose include an image designed for scheduling and an image obtained by modifying a Microsoft Window icon.

According to an apparatus and method for generating tactile sensation by using constellation metaphor, a tactile pattern is generated on the basis of an icon, which is simplified or symbolized, or an image shape of a symbol, and a tactile icon having a shape of dots and lines is visually provided by using constellation metaphor along with the provision of a tactile pattern. Therefore, there is an advantage in that the tactile pattern is easily generated, and a user can easily recognize the generated tactile pattern.

In particular, according to the present invention, a plurality of tactile generation apparatuses or systems are connected through a network so that tactile patterns and icons can be transmitted and received from one apparatus (or system) to another.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for generating tactile sensation by using constellation metaphor, the apparatus comprising:
a tactile generator generating a tactile pattern by using a shape of image inputted from a user and generating a tactile icon having a shape of dots and lines by using the constellation metaphor according to the tactile pattern;
a tactile indicator indicating a tactile sensation by using the generated tactile pattern; and
a display unit displaying the generated tactile icon.

2. The apparatus of claim 1, wherein the tactile generator divides the input image into a picture area and a background area, and generates the tactile pattern by simplifying an image for the picture area.

3. The apparatus of claim 2, wherein the tactile generator regulates a ratio and size of the input image so that the input image is optimized for the tactile indicator, allows the picture and background areas divided from the image to correspond to actuators constituting the tactile indicator, and generates the tactile pattern by activating only an actuator corresponding to the picture area.

4. The apparatus of claim 3, wherein, if it is determined that there is a existing tactile pattern having the same pattern as the activated actuator, the tactile generator adds dots or lines so as to distinguish the pattern of the activated actuator from the existing tactile pattern having the same pattern as the activated actuator, or provides a user's editing process.

5. The apparatus of claim 2, wherein the tactile generator allows locations of the activated actuators to be indicated by dots by using the constellation metaphor, and generates a tactile icon by connecting the indicated dots by lines.

6. The apparatus of claim 5, wherein, if it is determined that there is a existing tactile icon having the same shape as a figure formed by connecting the dots by lines, the tactile generator adds dots or lines so as to distinguish the figure from the existing tactile icon having the same shape as the figure, or provides a users editing process.

7. The apparatus of claim 1, wherein the tactile indicator is a physical stimulator including an actuator by which a plurality of pins vertically moves or vibrates.

8. The apparatus of claim 1, wherein the display unit further outputs a character format of an image name corresponding to the indicated tactile pattern.

9. The apparatus of claim 1, wherein the tactile generator comprises:
an image input unit receiving an image from the user and storing the image;
a tactile pattern generator generating a tactile pattern corresponding to the image; and
a tactile icon generator generating a tactile icon having a shape of dots and lines by using the constellation metaphor corresponding to the tactile pattern.

10. The apparatus of claim 1, further comprising an audio output unit outputting an audio format of an image name corresponding to the indicated tactile pattern.

11. A method of generating tactile sensation by using constellation metaphor, the method comprising:
generating a tactile pattern by using a shape of image input from a user;
generating a tactile icon having a shape of dots and lines by using the constellation metaphor corresponding to the tactile pattern;
indicating the generated tactile pattern as a tactile sensation; and
displaying the tactile icon corresponding to the tactile pattern indicated as the tactile sensation.

12. The method of claim 11, wherein the generating of a tactile pattern comprises:
regulating a ratio and size of the image inputted from the user so that the image is optimized for an area that indicates the tactile sensation;
dividing the optimized image into a picture area and a background area;
allowing the divided picture and background areas to correspond to actuators constituted to provide the tactile sensation; and
generating the tactile pattern in which only an actuator corresponding to the picture area is activated.

13. The method of claim 12, further comprising, if it is determined that there is a existing tactile pattern having the same pattern as the activated actuator, adding dots or lines so as to distinguish the pattern of the activated actuator from the existing tactile pattern having the same pattern as the activated actuator, or providing a user's editing process.

14. The method of claim 11, wherein the generating of a tactile icon corresponding to the tactile pattern comprises:
indicating locations of the activated actuators by dots by using the constellation metaphor;
connecting the indicated dots by lines; and
generating a figure formed by connecting the dots by lines as the tactile icon.

15. The method of claim 14, further comprising, if it is determined that there is a existing tactile icon having the same shape as a figure formed by connecting the dots by lines, adding dots or lines so as to distinguish the figure from the existing tactile icon having the same shape as the figure, or providing a user's editing process.

16. The method of claim 11, wherein, in the providing of the generated tactile pattern as a tactile sensation, the tactile sensation is indicated by using a physical stimulator including a plurality of pins of an actuator that vertically moves or vibrates.

17. The method of claim 11, further comprising outputting an audio format of an image name corresponding to the indicated tactile pattern.

18. The method of claim 11, further comprising displaying a character format of an image name corresponding to the indicated tactile pattern.
